(19) United States
(12) Patent Application Publication
(10) Pub. No.: US 2022/0092296 A1
(43) Pub. Date: Mar. 24, 2022

(54) METHOD FOR UPDATING DATA, ELECTRONIC DEVICE, AND STORAGE MEDIUM

(71) Applicant: SHENZHEN SENSETIME TECHNOLOGY CO., LTD., Shenzhen (CN)

(72) Inventors: Hongbin ZHAO, Shenzhen (CN); Wenzhong JIANG, Shenzhen (CN); Yi LIU, Shenzhen (CN)

(21) Appl. No.: 17/540,557

(22) Filed: Dec. 2, 2021

Related U.S. Application Data
(63) Continuation of application No. PCT/CN2020/088330, filed on Apr. 30, 2020.

(30) Foreign Application Priority Data
Jul. 16, 2019 (CN) 201910642110.0

(51) Int. Cl. G06K 9/00; G06K 9/62

(52) U.S. Cl. CPC G06K 9/00288; G06K 9/6288; G06K 9/6215; G06K 9/6202

(57) ABSTRACT

A method and device for updating data, an electronic device and a storage medium are provided. The method includes that: a first image of a target object is acquired, and a first image feature of the first image is acquired; a second image feature is acquired from a local face database; similarity comparison is performed between the first image feature and the second image feature to obtain a comparison result; responsive to that the comparison result is greater than a feature update threshold, a difference feature between the first image feature and the second image feature is acquired, and the difference feature is taken as a dynamic update feature; and the second image feature is adaptively updated according to the dynamic update feature to obtain updated feature data of the target object.

### CROSS-REFERENCE TO RELATED APPLICATION

The present application is a continuation of International Application No. PCT/CN 2020/088330 filed on Apr. 30, 2020, which is based upon and claims priority to Chinese patent application No. 201910642110.0 filed on Jul. 16, 2019. The contents of both applications are hereby incorporated by reference in their entirety.

### BACKGROUND

In a data matching scenario of computer vision, taking face recognition as an example, in a card punching scenario of punching in and out from work or a card punching situation in consideration of internal safety, at present, recognition of a card punching user is performed by comparing with a face image in a manually updated face database, and thus the processing efficiency is low.

### SUMMARY

The embodiments of the present disclosure relates to the field of computer vision technologies, and provide a method and device for updating data, an electronic device, and a storage medium.

In a first aspect, there is provided a method for updating data, which may include the following operations.

A first image of a target object is acquired, and a first image feature of the first image is acquired.

A second image feature is acquired from a local face database.

Similarity comparison is performed between the first image feature and the second image feature to obtain a comparison result.

Responsive to that the comparison result is greater than a feature update threshold, a difference feature between the first image feature and the second image feature is acquired, and the difference feature is taken as a dynamic update feature.

The second image feature is adaptively updated according to the dynamic update feature to obtain updated feature data of the target object.

In a second aspect, there is provided a device for updating data, which may include a collection unit, an acquisition unit, a comparison unit, a difference feature acquisition unit and an update unit.

The collection unit is configured to acquire a first image of a target object, and acquire a first image feature of the first image.

The acquisition unit is configured to acquire a second image feature from a local face database.

The comparison unit is configured to perform similarity comparison between the first image feature and the second image feature to obtain a comparison result.

The difference feature acquisition unit is configured to acquire, responsive to that the comparison result is greater than a feature update threshold, a difference feature between the first image feature and the second image feature, and take the difference feature as a dynamic update feature.

The update unit is configured to adaptively update the second image feature according to the dynamic update feature to obtain updated feature data of the target object.

In a third aspect, there is provided an electronic device, which may include: a processor, and a memory configured to store an instruction executable by the processor.

The processor may be configured to: acquire a first image of a target object, and acquire a first image feature of the first image; acquire a second image feature from a local face database; perform similarity comparison between the first image feature and the second image feature to obtain a comparison result; acquire, responsive to that the comparison result is greater than a feature update threshold, a difference feature between the first image feature and the second image feature, and to take the difference feature as a dynamic update feature; and adaptively update the second image feature according to the dynamic update feature to obtain updated feature data of the target object.

In a fourth aspect, there is provided a non-transitory computer-readable storage medium, which may have stored thereon a computer program instruction that, when executed by a processor, causes the processor to: acquire a first image of a target object, and acquire a first image feature of the first image; acquire a second image feature from a local face database; perform similarity comparison between the first image feature and the second image feature to obtain a comparison result; acquire, responsive to that the comparison result is greater than a feature update threshold, a difference feature between the first image feature and the second image feature, and to take the difference feature as a dynamic update feature; and adaptively update the second image feature according to the dynamic update feature to obtain updated feature data of the target object.

In a fifth aspect, there is provided a computer program product, which may include a computer-executable instruction that, when executed, to implement the method for updating data in the first aspect.

### BRIEF DESCRIPTION OF THE DRAWINGS

The accompanying drawings are incorporated in and constitute a part of the present disclosure. The drawings illustrate embodiments consistent with the present disclosure and, together with the description, serve to explain the technical solutions of the embodiments of the present disclosure.

FIG. 1 shows a flowchart of a method for updating data according to an embodiment of the present disclosure.

FIG. 2 shows a flowchart of a method for updating data according to an embodiment of the present disclosure.

FIG. 3 shows a flowchart of a method for updating data according to an embodiment of the present disclosure.

FIG. 4 shows a flowchart of a method for updating data according to an embodiment of the present disclosure.

FIG. 5 shows a block diagram of a device for updating data according to an embodiment of the present disclosure.

FIG. 6 shows a block diagram of an electronic device according to an embodiment of the present disclosure.

FIG. 7 shows a block diagram of an electronic device according to an embodiment of the present disclosure.

### DETAILED DESCRIPTION

Various exemplary embodiments, features and aspects of the present disclosure will be described below in detail with reference to the accompanying drawings. The same numerals in the accompanying drawings indicate the same or similar components. Although various aspects of the embodiments are illustrated in the accompanying drawings, the accompanying drawings are unnecessarily drawn according to a proportion unless otherwise specified.

As used herein, the word “exemplary” means “serving as an example, embodiment, or illustration”. Thus, any embodiment described herein as “exemplary” is not necessarily to be construed as preferred or advantageous over other embodiments.

The term “and/or” in the present disclosure is only an association relationship for describing associated objects and represents that three relationships may exist. For example, A and/or B may represent the following three cases: only A exists, both A and B exist, and only B exists. In addition, the term “at least one” herein represents any one of multiple or any combination of at least two in the multiple, for example, at least one of A, B or C may represent any one or multiple elements selected from a set formed by the A, the B and the C.

In addition, for describing the embodiments of the present disclosure better, many specific details are presented in the following specific implementation manners. It is to be understood by those skilled in the art that the embodiments of the present disclosure may still he implemented even without some specific details. In some examples, methods, means, components and circuits known very well to those skilled in the art are not described in detail, to highlight the subject of the embodiments of the present disclosure.

In an application scenario of face recognition, an employee needs to be subjected to card punching recognition through a card punching machine (i.e., an attendance machine) during punching in and out from work, or, a person with authority of entering a special office area needs to be subjected to card punching recognition in consideration of internal safety of the company. In some monitoring fields, it is also necessary to perform card punching recognition of people who enter and exit. In the process of card punching recognition, face image features captured in real time on site are compared with the existing face image features in the face database. However, the existing face image features stored in the face database may result in recognition failure clue to inaccuracies in acquisition when a target object is initially subjected to image acquisition, or the hairstyle change of the target object, or face fattening or thinning of the target object or the like, and thus results in low face recognition rate. In order to improve the face recognition rate, it is necessary to manually update the base pictures in the face database frequently (such as registered images obtained when the target object is initially subjected to image acquisition). The processing manner of manual updating has low processing efficiency. Therefore, according to the embodiments of the present disclosure, the registered images in the face database are adaptively updated, in other words, by continuously optimizing feature values of registered images, the face recognition rate can be improved, and the processing efficiency of updating of images in the face database can be improved.

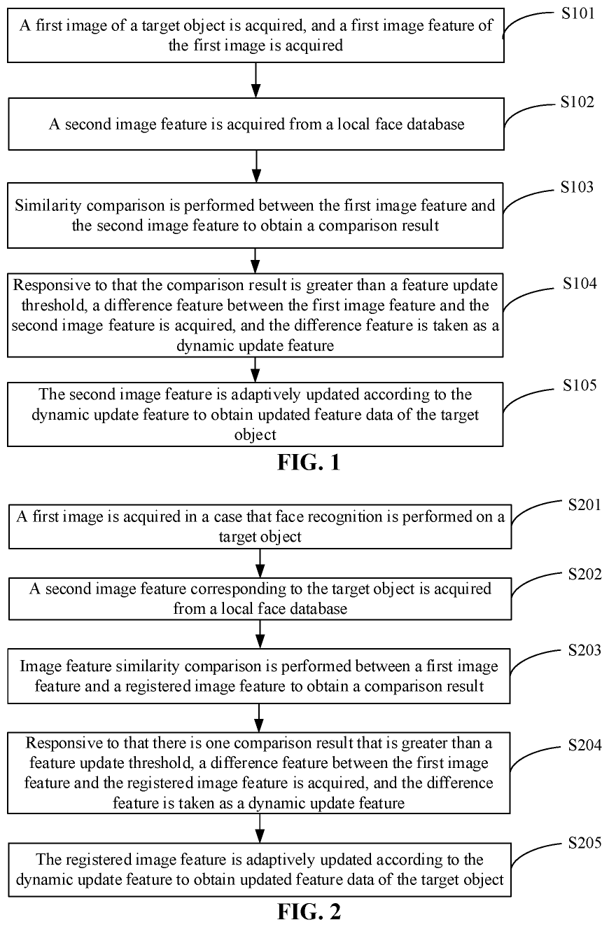

FIG. 1 shows a flowchart of a method for updating data according to an embodiment of the present disclosure. The method for updating data is applied to a device for updating data. For example, the device for updating data may be executed by a terminal device or a server or other processing devices, etc. The terminal device may be a User Equipment (UE), a mobile device, a cell phone, a cordless phone, a Personal Digital Assistant (PDA), a handheld device, a computing device, a vehicle-mounted device, a wearable device, etc. In some embodiments, the method for updating data may be implemented by a processor through calling a computer-readable instruction stored in a memory. As shown in FIG. 1, the process includes the following operations.

In operation S101, a first image of a target object is acquired, and a first image feature of the first image is acquired.

In one example, the target object (e.g., a company employee) needs to be subjected to card punching recognition by a card punching machine when accessing a door. The card punching recognition may be performed through fingerprint recognition or face recognition. Under the condition of the face recognition, a camera is adopted to capture the target object on site in real time, and an obtained face image is the first image.

In one example, the first image feature is extracted from the first image. The feature extraction may be performed on the first image according to a feature extraction network (e.g., a convolutional neural network (CNN) to obtain one or more feature vectors corresponding to the first image, and the first image feature may be obtained according to the one or more feature vectors. In addition to the feature extraction network, other networks may also be adopted to realize the feature extraction, which are included in the scope of protection of the embodiments of the present disclosure.

In operation 5102, a second image feature is acquired from a local face database.

In one example, the face recognition is performed, which means that the face image feature captured in real time on site is compared with the existing face image feature in the face database. The existing face image feature in the face database is the second image feature. The second image feature includes, but is not limited to: 1) the feature corresponding to a registered image obtained when the target object is initially subjected to image acquisition; and 2) an updated second image feature corresponding to the previous update, which is obtained through the process for updating data in the embodiments of the present disclosure.

In operation S103, similarity comparison is performed between the first image feature and the second image feature to obtain a comparison result.

In one example, during the feature extraction of an image, the first image feature may be extracted from the first image, the second image feature may be extracted from the second image, and image feature similarity comparison is performed between the first image feature and the second image feature to obtain a similarity score, and the similarity score is the comparison result. The first image feature and the second image feature are for reference and illustration only, are not limited to one feature and may be multiple features.

Considering; the requirements for recognition speed and recognition accuracy, if the second image feature is extracted from the second image in real time during recognition, the recognition speed and the recognition accuracy may be reduced. Therefore, in some embodiments, the second image feature is sent by a server and pre-stored locally. That is, before the second image feature is acquired from the local face database, the method includes that: the second image feature sent by the server is received, and the second image feature is stored into the local face database. For example, a “local recognition machine+server ” mode is adopted, the second image feature is extracted at the server, and then the server sends the second image feature (i.e. the image feature of the registered image) to the local recognition machine: the local recognition machine locally performs comparison, updates the second image feature sent to the local face database according to the comparison result, and still stores the updated second image feature into the local face database. The updated second image feature is stored locally rather than being uploaded to the server, because each server may correspond to N local recognition machines and different hardware configurations or software running environments of each local recognition machine may cause different image features. That is to say, storing the updated second image feature locally is a simple, efficient and high-recognition rate mode. In addition, under the condition of adopting the “local recognition machine+server” mode, the comparison result may be compared With a feature update threshold during recognition every time. If the comparison result is greater than the feature update threshold, a difference feature between the first image feature and the second image feature is acquired, the difference feature is taken as a dynamic update feature; and the second image feature is adaptively updated according to the dynamic update feature to obtain updated feature data of the target object.

In operation S104, responsive to that the comparison result is greater than the feature update threshold, the difference feature between the first image feature and the second image feature is acquired, and the difference feature is taken as the dynamic update feature.

In one example, after the feature extraction is performed on the image and the image feature similarity comparison is perform between the first image feature corresponding to the first image and the second image feature corresponding to the second image to obtain a similarity score (the similarity score is an example of the comparison result, and the comparison result is not limited to the similarity, but also to other parameters used for evaluating the comparison of the two images), the second image feature is adaptively updated according to the similarity score and the feature update threshold. If the similarity score is greater than the feature update threshold, the difference feature between the first image feature and the second image feature is acquired. For example, the image feature of the first image, that is different from the image feature of the second image, is taken as the difference feature for the second image according to the similarity score, and the difference feature is taken as the dynamic update feature. The difference feature may be different hair styles, whether to wear glasses or not, and/or the like.

In operation S105, the second image feature is adaptively updated according to the dynamic update feature to obtain the updated feature data of the target object.

In some embodiments, the operation that the second image feature is adaptively updated according to the dynamic update feature includes that: weighted fusion is performed on the difference feature and the second image feature to obtain the updated feature data of the target object. The updated feature data of the target object may be taken as the second image feature, and the second image feature may be stored into the local face database.

In some embodiments, the method further includes that: a prompt indicating successful recognition of the target object is displayed responsive to that the comparison result is greater than a recognition threshold. The recognition threshold is less than the feature update threshold. Whether the comparison result is compared With the recognition threshold or the comparison result is compared with the feature update threshold, the comparison result may be the same similarity score, and the recognition threshold is less than the feature update threshold. The comparison result and the recognition threshold may be compared firstly, and after recognition is passed to prove that the operator is the right person, the comparison result is then compared with the feature update threshold.

It is to be noted that in the adaptive updating process for the first time, taking a card punching scenario where an employee punches in and out from work as an example, the face image feature captured in real time on site during the punching in/out is compared with the registered image feature (i.e., the corresponding feature of the registered image that is obtained when the image acquisition is initially performed on the target object and that is stored into the face database, and the registered image is an original image). In each updating process after the adaptive updating for the first time, the face image feature captured in real time on site during punching in/out is compared with the updated dynamic image feature (i.e., the corresponding feature of a dynamic image obtained after the previous adaptive updating).

In the embodiments of the present disclosure, in a case that image feature comparison is performed between the first image feature (i.e., the face image feature of the target object that needs to be recognized, such as the face image feature captured in real time on site in the card punching scenario) and the second image feature (i.e., the face image feature of the target object that is stored in the face database, such as the existing face image feature in the face database), considering that the existing face image feature stored in the face database (i.e., the feature corresponding to the registered image or the original image) may cause recognition failure due to inaccuracies in acquisition when the target object is initially subjected to image acquisition, or the hairstyle change of the target object, or face fattening or thinning of the target object, or make-up or not make-up of the target object or the like, and thus results in low face recognition success rate. By performing image feature similarity comparison between the image feature of the face image captured in real time on site and the updated image feature obtained by continuously optimizing the existing face image feature in the face database through adaptive updating, the recognition rate is improved. Moreover, since the manual update of the existing face image in the face database in the related art is replaced, the existing image in the face database does not need to be manually updated frequently. The stored face image feature in the face database is continuously updated by comparing the face image feature captured in real time on site with the stored face image feature, so that the processing efficiency of updating the face image feature in the face database is improved.

FIG. 2 shows a flowchart of a method for updating data according to an embodiment of the present disclosure. The method for updating data is applied to a device for updating data. For example, the device for updating data may be executed by a terminal device or a server or other processing devices, etc. The terminal device may be a UE, a mobile device, a cell phone, a cordless phone, a PDA, a handheld device, a computing device, a vehicle-mounted device, a wearable device, etc. In some embodiments, the method for updating data may be implemented by a processor through calling a computer-readable instruction stored in a memory. As shown in FIG. 2, the second image is a registered image obtained when the target object is initially registered to a face recognition system, and the image feature corresponding to the highest similarity between the first image and the second image (i.e., the registered image) among the comparison results is taken as a dynamic update feature. The process includes the following operations.

In operation S201, a first image is acquired in a case that face recognition is performed on a target object.

In one example, for example, the target object (e.g., a company employee) needs to be subjected to card punching recognition by a card punching machine When punching in and out from work. The card punching recognition may be performed through fingerprint recognition or face recognition. Under the condition of the face recognition, a camera is adopted to capture the target object on site in real time, and an obtained face image is the first image.

In operation S202, a second image feature corresponding to the target object is acquired from a local face database.

In one example, the face recognition is performed, which means that a face image feature captured in real time on site is compared with the existing face image feature in the face database. The existing face image feature in the face database is the second image feature. The second image feature is the registered image obtained when performing image acquisition on the target object initially.

In operation S203, image feature similarity comparison is performed between a first image feature and a registered image feature to obtain a comparison result.

In one example, during feature extraction of an image, the first image feature may be extracted from the first image, and the image feature similarity comparison is performed between the first image feature and the second image feature i.e., the registered image feature) to obtain a similarity score, and the similarity score is the comparison result. The first image feature and the second image feature are for reference and illustration only, are not limited to one feature and may be multiple features.

In operation S204, responsive to that there is one comparison result that is greater than a feature update threshold, a difference feature between the first image feature and the registered image feature is acquired, and the difference feature is taken as a dynamic update feature.

The registered image feature is adaptively updated according to the similarity score and the feature update threshold. If the similarity score is greater than the feature update threshold, the difference feature between the first image feature and the registered image feature is acquired. For example, the image feature of the first image, that is different from the image feature of the registered image, is taken as the difference feature according to the similarity score, and the difference feature is taken as the dynamic update feature.

In operation S205, the registered image feature is adaptively updated according to the dynamic update feature to obtain updated feature data of the target object.

In the embodiments of the present disclosure, the image feature comparison is performed between the first image feature (i.e., the face image feature of the target object that needs to be recognized, such as the face image feature captured in real time on site in the card punching scenario) and the second image feature (i.e., the face image feature of the target object that is stored in the face database, such as the existing face image feature in the face database), which belongs to the adaptive updating process or the first time. Considering that the existing face image feature stored in the face database (i.e., the feature corresponding to the registered image or the original image) may cause recognition failure due to inaccuracies in acquisition when the target object is initially subjected to image acquisition, or the hairstyle change of the target object, or face fattening or thinning of the target object, or make-up or not make-up of the target object or the like, and thus results in low face recognition success rate. By performing image feature similarity comparison between the image feature of the face image captured in real time on site and the updated image feature obtained by continuously optimizing the existing face image feature in the face database (i.e., the feature corresponding to the registered image or the original image) through adaptive updating, the recognition rate is improved. Moreover, since the manual update of the existing face image in the face database in the related art is replaced, the stored image feature in the face database does not need to be manually updated frequently. The stored face image feature in the face database is continuously updated by comparing the face image feature captured in real time on site With the stored face image feature, so that the processing efficiency of updating the face image feature in the face database is improved.

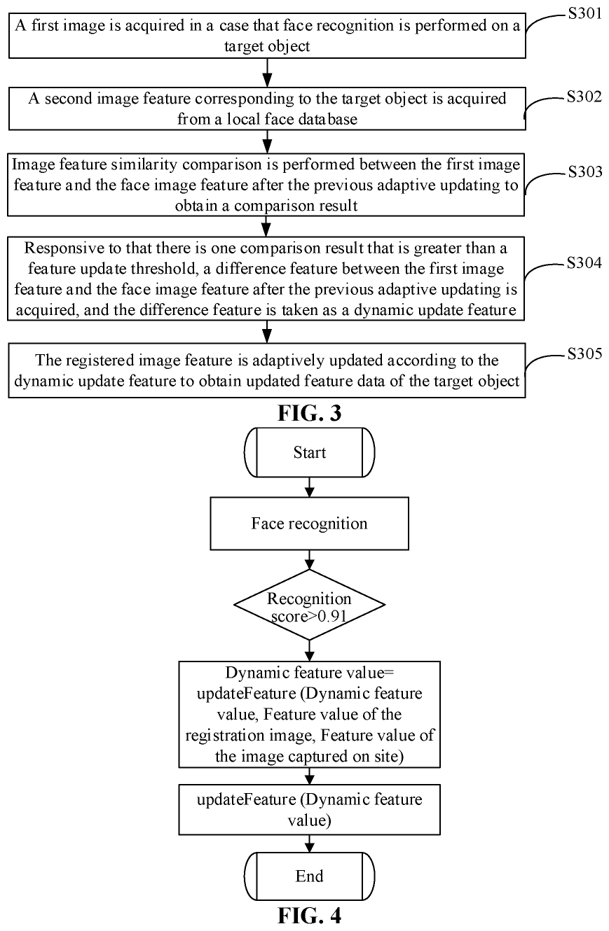

FIG. 3 shows a flowchart of a method for updating data according to an embodiment of the present disclosure. The method for updating data is applied to a device for updating data. For example, the device for updating data may be executed by a terminal device or a server or other processing devices, etc. The terminal device may be a UE, a mobile device, a cell phone, a cordless phone, a PDA, a handheld device, a computing device, a vehicle-mounted device, a wearable device, etc. In some embodiments, the method for updating data may be implemented by a processor through calling a computer-readable instruction stored in a memory. As shown in FIG. 3, the second image feature is an updated face image feature obtained after the previous adaptive updating or is called a dynamic updated image feature, and the image feature corresponding to the highest similarity between the first image feature and the second image feature (i.e., the second image feature continuously optimized and updated on the basis of the registered image, that is, the updated face image feature) among the comparison results is taken as the dynamic update feature. The process includes the following operations.

In operation S301, a first image is acquired in a case that face recognition is performed on a target object.

In one example, the target object (e.g., a company employee) needs to be subjected to card punching recognition by a card punching machine when punching in and out from work. The card punching recognition may be performed through fingerprint recognition or face recognition. Under the condition of the face recognition, a camera is adopted to capture the target object on site in real time, and an obtained face image is the first image.

In operation S302, a second image feature corresponding to the target object is acquired from a local face database.

In one example, the face recognition is performed, which means that a face image feature captured in real time on site is compared with the existing face image feature in the face database. The existing face image feature in the face database is the second image feature.

The second image feature is a second image feature obtained after the previous updating through the process for updating data of the embodiments of the present disclosure.

In operation S303, image feature similarity comparison is performed between the first image feature and the face image feature after the previous adaptive updating to obtain a comparison result.

In one example, during feature extraction of an image, the first image feature may be extracted from the first image, and the image feature similarity comparison is performed between the first image feature and the face image feature after the previous adaptive updating to obtain a similarity score, and the similarity score is the comparison result. The first image feature and the second image feature are for reference and illustration only, are not limited to one feature and may be multiple features.

In operation S304, responsive to that there is one comparison result that is greater than a feature update threshold, a difference feature between the first image feature and the face image feature after the previous adaptive updating is acquired, and the difference feature is taken as a dynamic update feature.

The face image feature after the previous adaptive updating is adaptively updated according to the similarity score and the feature update threshold. If the similarity score is greater than the feature update threshold, the difference feature between the first image feature and the face image feature after the previous adaptive updating is acquired. For example, the image feature of the first image, that is different from the face image feature after the previous adaptive updating, is taken as the difference feature according to the similarity score, and the difference feature is taken as the dynamic update feature.

In operation S305, the registered image feature is adaptively updated according to the dynamic update feature to obtain updated feature data of the target object.

In the embodiments of the present disclosure, image feature comparison is performed between the first image feature (i.e., the face image feature of the target object that needs to be recognized, such as the face image feature captured in real time on site in the card punching scenario) and the second image feature (i.e., the face image feature, after the previous adaptive updating, of the target object that is stored in the face database), which belongs to the adaptive updating processes for the second and subsequent times. Considering that the initial existing face image feature stored in the face database (i.e.,. the feature corresponding to the registered image or the original image) may cause recognition failure due to inaccuracies in acquisition when the target object is initially subjected to image acquisition, or the hairstyle change of the target object, or face fattening or thinning of the target object, or make-up or not make-up of a user or the like, and thus results in low face recognition rate. By performing image feature similarity comparison between the image feature of the face image captured in real time on site and the updated image feature obtained. by continuously optimizing the existing face image feature in the face database (i.e., the feature corresponding to the registered image or the original image) through adaptive updating, so that similarity comparison with the face image feature after the previous adaptive updating is continuously performed in the adaptive updating processes for the second and subsequent times, thus the recognition rate is improved. Moreover, since the manual update of the existing face image feature in the face database in the related art is replaced, the stored image feature in the face database does not need to be manually updated frequently. The stored face image feature in the face database is continuously updated by comparing the face image feature captured in real time on site with the stored face image feature, so that the processing efficiency of updating the face image feature in the face database is improved.

In some embodiments, the operation that the second image feature is adaptively updated according to the dynamic update feature includes that: the dynamic update feature is fused into the existing feature value of the second image feature obtained after the previous adaptive updating, according to a configured weight value, so as to realize the adaptive updating. According to the embodiments of the present disclosure, a new feature value with high similarity score may be fused into an original feature value according to a preset weight (feature value fusion is performed by capturing a face feature of a scene image, so that the recognition passing rate under different recognition environments can be better improved), and the feature value of the registered image is continuously optimized.

In one example, in the adaptive updating, in a card punching scenario, the first image represents a current face image acquired when a user punches a card; and the second image represents a dynamic feature fused face image obtained by continuously adaptively updating and optimizing an initial registered image in a face database. The registered image is an image that is obtained when the user initially registers to a card punching system and that is stored in the face database. Since image feature comparison is specifically adopted during image comparison, the feature corresponding to the first image is represented by x′, which refers to the feature corresponding to the face image captured in real time on site under the current card punching condition; the feature corresponding to the second image is represented by x, which refers to the feature corresponding to the updated second image (i.e., the second image obtained by continuously optimizing and updating on the basis of the registered image, namely the updated face image) obtained by fusing the dynamic update feature (i.e., the feature to be fused which is to be updated to the face feature of the second image in the adaptive updating process) into the existing image; and the feature corresponding to the registered image is represented by x₀, which refers to an original image or registered image registered to the face recognition system by the user. x′ is compared with x to obtain a comparison result (for example, image feature similarity comparison is performed to obtain a similarity score), and if the similarity score is greater than a recognition threshold, recognition is passed, and card punching is successful. After recognition is passed, it can be proved that the user is the right person, the adaptive updating of the existing image feature in the face database is triggered, and the adopted formula is as follows: x←αx+(1−α)x′. For example, α=0.95, but in order to keep that the feature x corresponding to the updated second image obtained by Rising the dynamic update feature (i.e., the feature to be fused which is to be updated to the face feature of the second image in the adaptive updating process) into the existing image in the current adaptive update process is not too far away from the feature x₀ corresponding to the registered image, ∥x−x∥₂<β should be met, where α is the feature update threshold, and β is the weight.

In one example, before image feature similarity comparison is performed between the first image feature and the second image feature to obtain the comparison result, the method further includes that: in a case that the first image feature and the second image feature are subjected to image feature matching and a matching result is greater than the recognition threshold, an instruction indicating that the card punching recognition is passed is sent to the target object: and the process of adaptively updating the second image is triggered. In the embodiments of the present disclosure, after it is proved that the target object is the right person by matching with the recognition threshold, data updating is triggered. Specifically, the similarity score is compared with the feature update threshold, and if the similarity score is greater than the feature update threshold, the currently extracted “dynamic update feature” (or simply referred to as “dynamic feature value”), such as glasses, color pupils or dyed hair, is fused into the updated and optimized second image obtained by updating and optimizing continuously on the basis of the registered image previously, that is, continuous adaptive updating of the face image is realized in the updated face image. It is proved that the person is the right person by matching with the comparison recognition threshold, which includes that: 1) a face image captured in real time on site (such as a card punching image) is matched with a registered image obtained when the target object is initially subjected to image acquisition, and 2) the face image captured in real time on site (such as the card punching image) is matched with the updated second image (the updated image corresponding to the previous updating that is obtained through the processor for updating data of the embodiments of the present disclosure). The dynamic update feature (or simply referred to as “dynamic feature value”) is the feature to be fused which is to be updated to the second image face feature in the adaptive update process.

FIG. 4 shows a flowchart of a method for updating data according to an embodiment of the present disclosure. In the example, when the similarity score based on the current face feature is compared with the feature update threshold in the adaptive updating process, the similarity score may be compared with the registered face feature at the time of registration or may be compared with the updated face feature. Compared with the registered face feature at the time of registration in the adaptive updating process, the included content is as shown in FIG. 4: 1) recognition passing: an employee uses a face recognition system of a company for face card punching recognition, a face is registered into a face database firstly to obtain a registered face image; the employee compares a current card punching face feature (i.e., a face feature corresponding to a face image captured on site) captured by a camera with the existing face feature (including a registered face feature during the adaptive updating for the first time, and an updated face image obtained by continuously optimizing and updating on the basis of the registered image) in the face database, and if the similarity is greater than a set recognition threshold, it is determined that the operator is the employee; 2) adaptive updating: the current card punching face feature of the employee is compared with the existing face feature (including the registered face feature during the adaptive updating for the first time, and the updated face image obtained by continuously optimizing and updating on the basis of the registered image) in the face database, if the comparison result (such as the similarity score) is greater than a set feature update threshold (such as 0.91), image adaptive updating is performed according to the dynamic feature value of the card punching face feature different from the updated face image feature, that is, the current card punching face feature is fused again with the updated face image feature obtained after the previous adaptive updating. Here, dynamic feature value=updateFeature (dynamic feature value, feature value of registered face, and feature value of current card punching face). When the user punches the card next time, the current card punching face feature captured by the camera is compared with the updated face feature obtained after the previous adaptive updating. It is pointed out that it is also possible to compare the card punching face feature with the initial feature of the registered image once before the adaptive updating, and to trigger the adaptive updating only if the comparison result is larger than the feature update threshold, which has the advantages that: inaccuracy in feature updating caused by too much difference between the dynamic feature value used for fusion and the initial feature of the registered face can be avoided.

Application example:

Considering a face feature x of a user that currently needs to be dynamically updated and is fused into the face database, a card punching face feature x′ acquired by the camera on site currently and successful card punching, x←αx+(1−α)x′ For example, α=0.95, but in order to keep that the face feature x is not too far away from an initial registered image feature x₀ in the face database, ∥x−x₀∥₂<β should be met, where α is the feature update threshold, and β is the weight.

This method is mainly used for continuously optimizing the feature value of the registered image by fusing the feature value with a new high score into the original feature value according to a certain weight in the case that the recognition is passed and the similarity score is greater than a set feature update threshold (update_threshold), so that the function of improving the recall of the person is achieved, in other words, the function of improving recognition rate of the face of the target object is achieved.

This method includes the following contents.

1) An initial value may be set firstly, as follows:

update_threshold: if a new similarity score of a person on site is greater than the feature update threshold the method is called to update the existing feature value:

minimum_update_weight: a minimum weight, which is set to 0.85 at the present stage, and may be modified according to actual requirements:

maximum_update_weight: a maximum weight, which is set 0.95 at the present stage, and may be modified according to actual requirements.

For weights, the possible value range for characterizing the feature update threshold is from 0.85 to 0.95, such as 0.91.

According to the calling method set above, the update_threshold parameter is called firstly and the minimum weight and the maximum weight are obtained, and the update_threshold parameter is assigned to float within the value range of 0.85-0.95.

2) Three feature values may be set, including a feature value of a registered face image, a feature value of a face image in a current face database, and a feature value of an image captured on site currently (i.e. a current card punching image). The comparison is the comparison between the feature value of the image captured on site currently and the feature value in the current face database, and adaptive updating according to a relationship between the comparison result and the feature update threshold is the adaptive updating of the feature value in the current face database. In order to prevent the “dynamic update feature” (or simply referred to as “dynamic feature value”) used for fusion from being too different from the initial feature of the original image of the registered face, the initial feature of the registered face may be compared with the feature of the image captured on site currently once before the adaptive updating, and the updating is performed only if the comparison result is greater than the feature update threshold. There may be two thresholds, including a recognition threshold and a feature update threshold, the feature update threshold is generally greater than the recognition threshold.

A recognition passing process may also be added before the image adaptive updating, the recognition threshold at the time of comparison is represented by adopting a compare_threshold, and if a comparison result of image feature values (a card punching face feature and an updated face feature obtained after the previous adaptive updating) is greater than the recognition threshold, it is determined that the recognition is successful, and a prompt indicating successful recognition is displayed.

3) In the subsequent process of face feature comparison, if the similarity comparison result of the image features (the card punching face feature is compared with the updated face feature obtained after the previous adaptive updating) is greater than the update_threshold, and the following method is called to update the feature value of the face. For example, all face features corresponding to the user in the face database are extracted, and current face dynamic features (to-be-fused features for the updated face features) of the user and current card punching face features of the user are extracted. The similarity score of the current card punching face dynamic feature and the face feature obtained after the previous adaptive updating is calculated, the similarity score is compared with the update_threshold, and if the similarity score is greater than the update_threshold, the dynamic feature value is updated into the existing face feature of the face database. Specifically, the dynamic feature value is the feature value of the current card punching face feature different from the updated face image feature.

It may be understood by the person skilled in the art that in the method of the specific implementation manners, the writing sequence of each operation does not mean a strict execution sequence to form any limit to the implementation process, and the specific execution sequence of each operation may be determined in terms of the function and possible internal logic.

The various method embodiments mentioned in the present disclosure may be combined with each other to form a combined embodiment without departing from the principle logic.

In addition, the embodiments of the present disclosure also provide a device far updating data, an electronic device, a computer-readable storage medium and a program, which may be used for implementing any method far updating data provided by the embodiments of the present disclosure, and the corresponding technical solution and description may refer to the corresponding description of the method part.

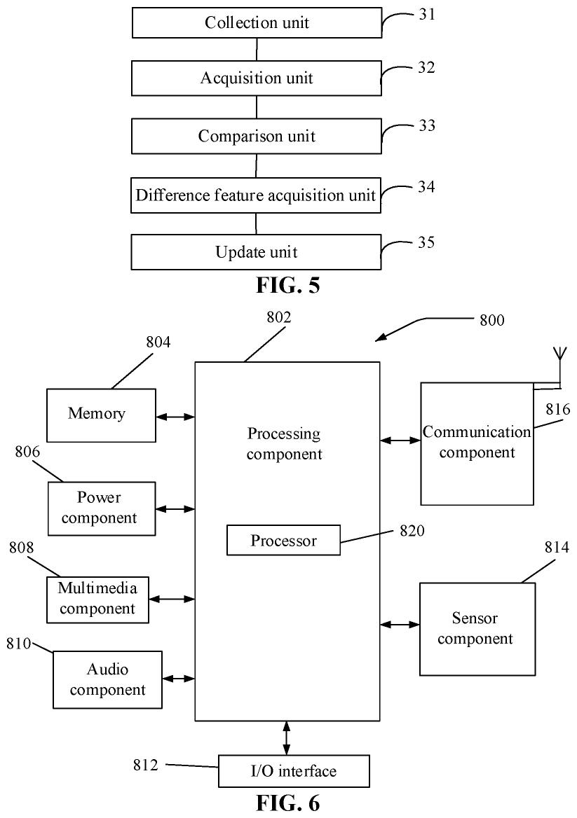

FIG. 5 shows a block diagram of a device for updating data according to an embodiment of the present disclosure. As shown in FIG. 5, the device for updating data according to the embodiments of the present disclosure includes: a collection unit 31, configured to acquire a first image of a target object, and acquire a first image feature of the first image; an acquisition unit 32, configured to acquire a second image feature from a local face database; a comparison unit 33, configured to perform similarity comparison between the first image feature and the second image feature to obtain a comparison result; a difference feature acquisition unit 34, configured to acquire, responsive to that the comparison result is greater than a feature update threshold, a difference feature between the first image feature and the second image feature, and to take the difference feature as a dynamic update feature; and an update unit 35, configured to adaptively update the second image feature according to the dynamic update feature to obtain updated feature data of the target object.

In some embodiments, the device further includes a storage unit, configured to receive the second image feature sent by a server, and store the second image feature into the local face database.

In some embodiments, the update unit is configured to perform weighted fusion on the difference feature and the second image feature to obtain the updated feature data of the target object.

In some embodiments, the device further includes a storage unit, configured to take the updated feature data of the target object as the second image feature, and store the second image feature.

In some embodiments, the device further includes a recognition unit, configured to display a prompt indicating successful recognition of the target object responsive to that the comparison result is greater than a recognition threshold, here, the recognition threshold is less than the feature update threshold.

In some embodiments, the functions or modules contained in the device provided in the embodiments of the present disclosure may be configured to perform the methods described in the above method embodiments. The specific implementation may refer to the description of the above method embodiments.

The embodiments of the present disclosure also provide a computer-readable storage medium, which has stored thereon a computer program instruction that, when executed by a processor, causes the processor to implement the above methods. The computer-readable storage medium may be a non-transitory computer-readable storage medium.

The embodiments of the present disclosure also provide an electronic device, which includes: a processor; and a memory configured to store an instruction executable by the processor, here, the processor is configured to execute the above methods.

The electronic device may be provided as a terminal, a server or other types of devices.

FIG. 6 is a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment, or a PDA.

Referring to FIG. 6. the electronic device 800 may include one or more of the following components: a processing component 802, a memory 804, a power component 806, a multimedia component 808, an audio component 810, an Input/ Output (I/O) interface 812, a sensor component 814, and a communication component 816.

The processing component 802 typically controls overall operations of the electronic device 800, such as the operations associated with display, telephone calls, data communications, camera operations, and recording operations, The processing component 802 may include one or more processors 820 to execute instructions to perform all or part of the steps in the above described methods. Moreover, the processing component 802 may include one or more modules which facilitate the interaction between the processing component 802. and other components. For example, the processing component 802 may include a multimedia module to facilitate the interaction between the multimedia component 808 and the processing component 802.

The memory 804 is configured to store various types of data to support the operation. of the electronic device 800. Examples of such data include instructions for any applications or methods operated on the electronic device 800, contact data, phonebook data, messages, pictures, video, etc. The memory 804 may be implemented by using any type of volatile or non-volatile memory devices, or a combination thereof, such as a Static Random Access Memory (SRAM). an Electrically Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

The power component 806 provides power to various components of the electronic device 800. The power component 806 may include a power management system, one or more power sources, and any other components associated with the generation, management and distribution of power in the electronic device 800.

The multimedia component 808 includes a screen providing an output interface between the electronic device 800 and the user. In some embodiments, the screen may include a Liquid Crystal Display (LCD) and a Touch Panel (TP). If the screen includes the TP, the screen may be implemented as a touch screen to receive input Signals from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the electronic device 800 is in an operation mode, such as a photographing mode or a video mode. Each of the front camera and the rear camera. may be a fixed optical lens system or have focus and optical zoom capability,

The audio component 810 is configured to output and/or input audio signals. For. example, the audio component 810 includes a Microphone (MIC) configured to receive an. external audio signal When the electronic device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, or buttons. The buttons may include, but are not limited to, a home button, a volume button, a starting button, and a locking button.

The sensor component 814 includes one or more sensors to provide status assessments of various aspects of the electronic device 800. For example, the sensor component 814 may detect an open/closed status of the electronic device 800, and relative positioning of components. For example, the component is the display and the keypad of the electronic device 800. The sensor component 814 may also detect a change in position of the electronic device 800, or a component of the electronic device 800, a presence or absence of user contact with the electronic device 800, an orientation or an acceleration/deceleration of the electronic. device 800, and a change in temperature of the electronic device 800. The sensor component 814 may include a proximity sensor configured to detect the presence of nearby objects without any physical contact. The sensor component 814 may also include a light sensor, such as a Complementary Metal Oxide Semiconductor (CMOS) or Charge Coupled Device (CCD) image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate communication, wired car wirelessly, between the electronic device 800 and other devices. The electronic device 800 may access a wireless network based on a communication standard, such as WiFi, 2.0 or 3G, or a combination thereof. In one exemplary embodiment, the communication component 816 receives a broadcast signal or broadcast associated information from an external broadcast management system via a broadcast channel. In one exemplary embodiment, the communication component 816 further includes a Near Field Communication (NFC) module to facilitate short-range communications. For example. the NFC module may be implemented based on a Radio Frequency Identification (RFID) technology, an Infrared Data. Association (IrDA) technology, an Ultra Wide Band (UWB) technology, a Bluetooth (BT) technology, and other technologies.

In exemplary embodiments, the electronic device 800 may be implemented with one or more Application Specific Integrated Circuits (ASICs), Digital Signal Processors (DSPs), Digital Signal Processing Devices (DSPD), Programmable Logic Devices (PLDs), Field Programmable Gate Arrays (FPGAs), controllers, micro-controllers, microprocessors, or other electronic elements, for performing the above described methods.

In an exemplary embodiment, a non-volatile computer-readable storage medium, for example, a memory 804 including a computer program instruction, is also provided. The computer program instruction may be executed by a processor 820 of an electronic device 800 to implement the above-mentioned methods.

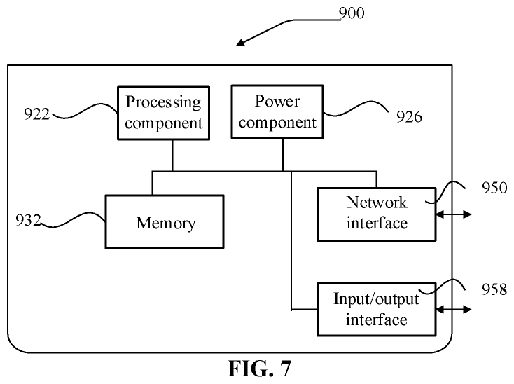

FIG. 7 is a block diagram of an electronic device 900 according to an exemplary embodiment. For example, the electronic device 900 may be provided as a server. Referring to FIG. 7, the electronic device 900 includes a processing component 922, further including one or more processors, and a memory resource represented by a memory 932, configured to store an instruction executable for the processing component 922, for example, an application program. The application program stored in the memory 932 may include one or more modules, with each module corresponding to one group of instructions. In addition, the processing component 922 is configured to execute the instruction to execute the above-mentioned method.

The electronic device 900 may further include a power component 926 configured to execute power management of the electronic device 900, a wired or wireless network interface 950 configured to connect the electronic device 900 to a network and an interface 958. The electronic device 900 may be operated based on an operating system stored in the memory 932, for example. Windows Server™, Mac OS X™, Unix™, Linux™, FreeBSD™ or the like.

In an exemplary embodiment, a non-volatile computer-readable storage medium, for example, a memory 932 including a computer program instruction, is also provided. The computer program instruction may be executed by a processing component 922 of an electronic device 900 to implement the above-mentioned methods.

The embodiments of the present disclosure may be a system, a method and/or a computer program product. The computer program product may include a computer-readable storage medium, which has stored thereon a computer-readable program instruction for enabling a processor to implement each aspect of the embodiments of the present disclosure is stored.

The computer-readable storage medium may be a physical device capable of retaining and storing an instruction used by an instruction execution device. The computer-readable storage medium may be, but not limited to, an electric storage device, a magnetic storage device, an optical storage device, an electromagnetic storage device, a semiconductor storage device or any appropriate combination thereof More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital. Video Disk (DVD), a memory stick, a floppy disk, a mechanical coding device, a punched card or in-slot raised structure with an instruction stored therein, and any appropriate combination thereof Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as an Internet, a Local. Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the embodiments of the present disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some embodiments, an electronic circuit, such as a programmable logic circuit. an FPGA or a Programmable Logic Array (PLA), is customized by using state information of the computer-readable program instruction. The electronic circuit may execute the computer-readable program instruction to implement each aspect of the embodiments of the present disclosure.

Herein, each aspect of the embodiments of the present disclosure is described with reference to flowcharts and/or block diagrams of the method, device (system) and computer program product according to the embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer pro gram product according to multiple embodiments of the present disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the present disclosure has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand each embodiment disclosed herein.

The above is only the specific implementation mode of the embodiments of the present disclosure and not intended to limit the scope of protection of the embodiments of the present disclosure, Any variations or replacements apparent to those skilled in the art within the technical scope disclosed by the embodiments of the present disclosure shall fall within the scope of protection of the embodiments of the present disclosure. Therefore, the scope of protection of the embodiments of the present disclosure shall be subjected to the scope of protection of the claims.

### INDUSTRIAL APPLICABILITY

In the embodiments of the present disclosure, the device for updating data acquires a first image of a target object, acquires a first image feature of the first image, acquires a second image feature from a local face database, performs similarity comparison between the first image feature and the second image feature to obtain a comparison result, acquires, responsive to that the comparison result is greater than a feature update threshold, a difference feature between the first image feature and the second image feature, takes the difference feature as a dynamic update feature, and adaptively updates the second image feature according to the dynamic update feature to obtain updated feature data of the target object. The device for updating data in the embodiments of the present disclosure do not need to frequently manually update base pictures in the face database, thereby improving the recognition efficiency.

1. A method for updating data, comprising:
acquiring a first image of a target object, and acquiring a first image feature of the first image;
acquiring a second image feature from a local face database;
performing similarity comparison between the first image feature and the second image feature to obtain a comparison result;
acquiring, responsive to that the comparison result is greater than a feature update threshold, a difference feature between the first image feature and the second image feature, and taking the difference feature as a dynamic update feature; and
adaptively updating, the second image feature according to the dynamic update feature to obtain updated feature data of the target object.

2. The method according to claim 1, further comprising: before acquiring the second image feature from the local face database,
receiving the second image feature sent by a server, and storing the second image feature into the local face database.

3. The method according to claim 1, wherein adaptively updating the second image feature according to the dynamic update feature comprises:
performing weighted fusion on the difference feature and the second image feature to obtain the updated feature data of the target object,

4. The method according to claim 1, wherein the updated feature data of the target object is taken as the second image feature, and the second image feature is stored.

5. The method according to claim 1, further comprising:
displaying a prompt indicating successful recognition of the target object responsive to that the comparison result is greater than a recognition threshold, wherein the recognition threshold is less than the feature update threshold.

6. The method according to claim 2, wherein adaptively updating the second image feature according to the dynamic update feature comprises:
performing weighted fusion on the difference feature and the second image feature to obtain the updated feature data of the target object.

7. The method according to claim 3, wherein the updated feature data of the target object is ken as the second image feature, and the second image feature is stored.

8. The method according to claim 3, further comprising:
displaying a prompt indicating successful recognition of the target object responsive to that the comparison result is greater than a recognition threshold, wherein the recognition threshold is less than the feature update threshold.

9. An electronic device, comprising:
a processor; and
a memory configured to store an instruction executable by the processor,
wherein the processor is configured:
acquire a first image of a target object, and acquire a first image feature of the first image;
acquire a second image feature from a local face database;
perform similarity comparison between the first image feature and the second image feature to obtain a comparison result;
acquire, responsive to that the comparison result is greater than a feature update threshold, a difference feature between the first image feature and the second image feature, and to take the difference feature as a dynamic update feature; and
adaptively update the second image feature according to the dynamic update feature to obtain updated feature data of the target object.

10. The electronic device according to claim 9, wherein the processor is further configured to:
receive the second image feature sent by a server, and store the second image feature into the local face database.

11. The electronic device according to claim 9, wherein the processor is further configured to:
perform weighted fusion on the difference feature and the second image feature to obtain the updated feature data of the target object.

12. The electronic device according to claim 9, wherein the processor is further configured to:
take the updated feature data of the target object as the second image feature, and store the second image feature.

13. The electronic device according to claim 9, wherein the processor is further configured to:
display a prompt indicating successful recognition of the target object responsive to that the comparison result is greater than a recognition threshold, wherein the recognition threshold is less than the feature update threshold.

14. A non-transitory computer-readable storage medium, having stored thereon a computer program instruction that, when executed by a processor, causes the processor to:
acquire a first image of a target object, and acquire a first image feature of the first image;
acquire a second image feature from a local face database;
perform similarity comparison between the first image feature and the second image feature to obtain a comparison result:
acquire, responsive to that the comparison result is greater than a feature update threshold, a difference feature between the first image feature and the second image feature, and to take the difference feature as a dynamic update feature: and
adaptively update the second image feature according to the dynamic update feature to obtain updated feature data of the target object.

15. The non-transitory computer-readable storage medium according to claim 14, wherein the computer program instruction causes the processor to: receive the second image feature sent by a server, and store the second image feature into the local face database.

16. The non-transitory computer-readable storage medium according to claim 14, wherein the computer program instruction causes the processor to: perform weighted fusion on the difference feature and the second image feature to obtain the updated feature data of the target object.

17. The non-transitory computer-readable storage medium according to claim 14, wherein the computer program instruction causes the processor to: take the updated feature data of the target object as the second image feature, and store the second image feature.

18. The non-transitory computer-readable storage medium according to claim 14, wherein the computer program instruction causes the processor to: display a prompt indicating successful recognition of the target object responsive to that the comparison result is greater than a recognition threshold, wherein the recognition threshold is less than the feature update threshold.
